(19) United States
(12) Patent Application Publication
(10) Pub. No.: US 2007/0187208 A1
(43) Pub. Date: Aug. 16, 2007

(54) Lock structure

(75) Inventor: Yuan-Chien Tsai, Taipei City (TW)

Correspondence Address: TROXELL LAW OFFICE PLLC, SUITE 1404, 5205 LEESBURG PIKE, FALLS CHURCH, VA, 22041, US

(73) Assignees: Somers Co., Ltd.; Albert Bonan

(21) Appl. No.: 11/350,820

(22) Filed: Feb. 10, 2006

(51) Int. Cl. G07F 7/00

(52) U.S. Cl. 194/205

(57) ABSTRACT

A lock structure comprises an upper shell and a lower shell. A traverse through hole is formed between the assembled upper and lower shells. A coin insertion slot and a key plate insertion slot are oppositely formed on the upper shell. A stopping mechanism is pivotally mounted inside the upper shell. A restoring mechanism is mounted below the stopping mechanism. The restoring mechanism and the stopping mechanism can be driven and shifted by each other. Two swing arms are oppositely, pivotally mounted on the stopping mechanism. Two recessed edges are formed on the swing arms. Two hooks are mounted on the swing arms, respectively. A spring is coupled with the swing arms for forming front and rear clipping openings so as to clip a coin or a key plate. The restoring mechanism is composed of a second spring and two push plates. The push plates are coupled with another spring.

### FIELD OF THE INVENTION

The present invention relates to a lock structure suitable for a shopping cart of a shopping center or the like to prevent the external force from pulling out a coin or a key plate.

### BACKGROUND OF THE INVENTION

With the income increase and the absence of shopping time in peacetime for double salary families, more and more shopping centers are built in many places to accommodate to the newly generated consumption style of buying all required commodities in holiday. Besides, all of these shopping centers supply large-sized, wheeled shopping carts for the consumers' convenience such that the consumers can pick out commodities and put them in the shopping carts.

For the purpose of managing the shopping carts, the coin locks with attached key plates are coupled with the shopping carts such that the disordered shopping carts can be ranked by locking the shopping carts to one another. If there is a need for a consumer to utilize the shopping carts, the coin must be inserted into the coin insertion slot of the coin lock of the last shopping cart and pushed inwardly to reject the key plate of another shopping cart from this shopping cart, whereby this shopping cart can be separated from this rank. On the contrary, if there is a need to return this shopping cart, this shopping cart is inserted into this rank. Thereafter, the key plate of another shopping cart is inserted into the key plate insertion slot of this shopping cart so as to reject the inserted coin.

The above-mentioned conventional lock structure is suitable for the shopping carts of the shopping centers worldwide. Therefore, its coin insertion slot has a larger dimension for the insertion of the coins of different countries. As a result, the clipping structure located inside the key plate insertion slot also has a larger size. However, a person who has a bad intention can pull out the coin or the key plate by applying a slightly large force.

In view of the foregoing problem, the present inventor makes diligent studies in providing consumers with a lock structure that can prevent the external force from pulling out the key plate or the coin in accordance with the motive of the present invention.

### SUMMARY OF THE INVENTION

It is a main object of the present invention to provide an improved lock structure that can tightly hold the key plate or the coin for preventing the external force from pulling out the key plate or the coin.

In order to achieve the above-mentioned object, the lock structure comprises an upper shell and a lower shell. A predetermined traverse through hole is formed between the assembled upper and lower shells. A coin insertion slot and a key plate insertion slot are oppositely formed on the upper shell. A stopping mechanism is pivotally mounted inside the upper shell. A restoring mechanism is mounted below the stopping mechanism. The restoring mechanism and the stopping mechanism are driven and shifted by each other. Two swing arms are oppositely, pivotally mounted on the stopping mechanism. Two recessed edges are formed on front ends of the swing arms, respectively. Two hooks are mounted inwardly on rear ends of the swing arms, respectively. A first spring is coupled with the rear ends of the swing arms for forming a front clipping opening and a rear clipping opening to clip a coin or a key plate. The restoring mechanism is composed of a second spring and two push plates. The push plates are coupled with two ends of the second spring, respectively. As a result, when the swing arms are coupled with the upper shell via a coupling hole of the second spring, the clipping openings are located to align with the insertion slots in normal state. As a result, the coin or the key plate can be firmly held in the insertion slots to prevent the external force from pulling out the coin and the key plate.

The aforementioned objects and advantages of the present invention will be readily clarified in the description of the preferred embodiments and the enclosed drawings of the present invention.

### BRIEF DESCRIPTION OF THE DRAWINGS

FIG. 1 is a schematic, three-dimensional view showing the preferred embodiment of the present invention.

FIG. 2 is a schematic, exploded view showing the preferred embodiment of the present invention.

FIG. 3 is a schematic, cross-sectional view showing the insertion of the coin in accordance with the preferred embodiment of the present invention.

FIG. 4 is a schematic, cross-sectional view showing the insertion of the key plate in accordance with the preferred embodiment of the present invention.

FIG. 5 is a view showing an application example of the preferred embodiment of the present invention.

### DETAILED DESCRIPTION OF THE PREFERRED EMBODIMENT

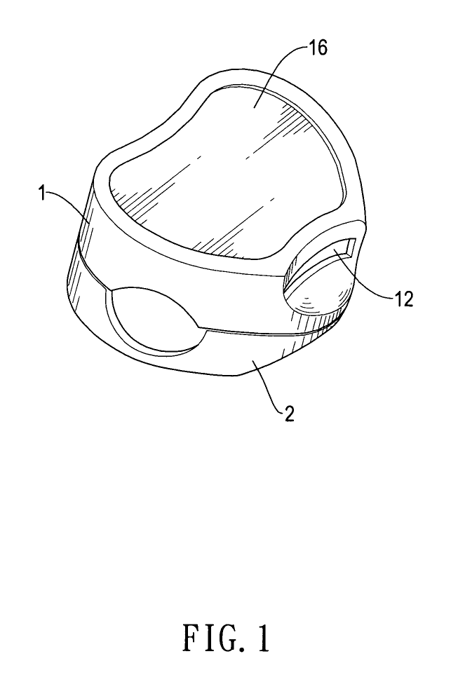

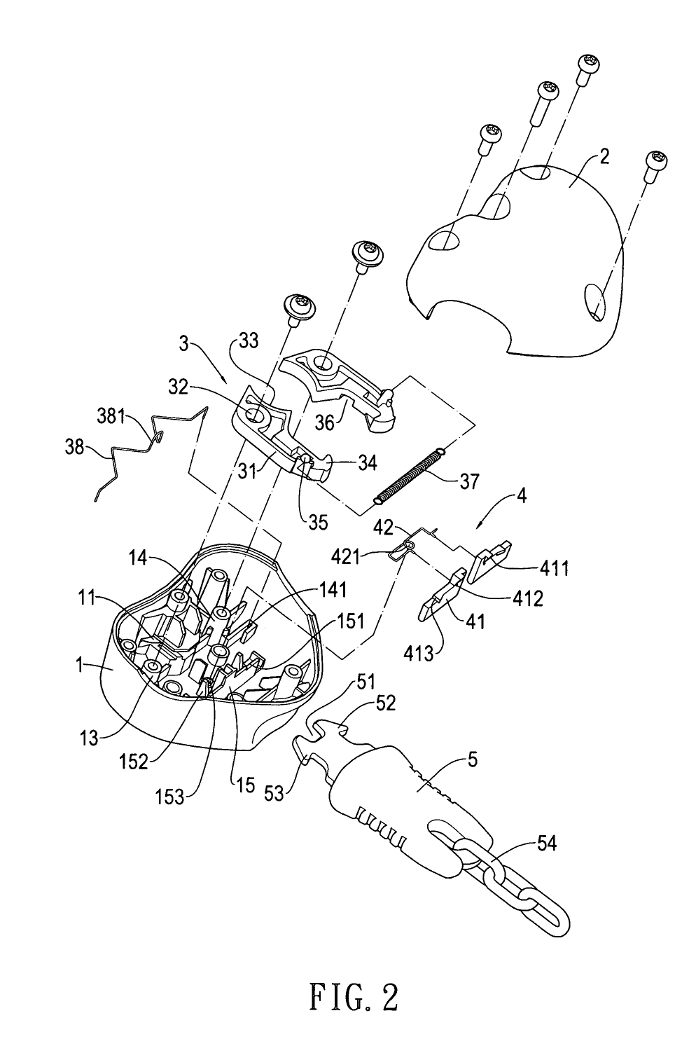

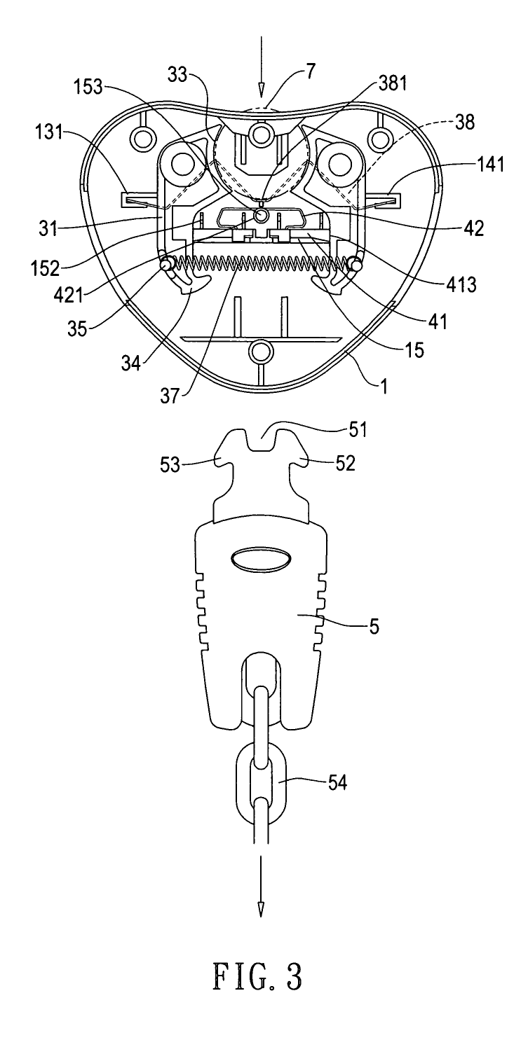

Referring to FIG. 1 through FIG. 3, an improved lock structure of the present invention comprises an upper shell 1, a lower shell 2, a stopping mechanism 3, a restoring mechanism 4, and a key plate 5, wherein the stopping mechanism 3 and the restoring mechanism 4 are mounted inside the upper shell 1. The lower shell and the upper shell are screwed to each other for forming a predetermined traverse through hole. A coin insertion slot 11 and a key plate insertion slot 12 are oppositely formed on the front and the back of the upper shell 1, respectively. Several screw bolts are mounted on the inside of the upper shell 1 for being coupled with the lower shell 2. Two pivotal bolts 13, 14 are mounted in proper positions of the upper shell 1 and located on both sides of the coin insertion slot 11, respectively. Two trench-shaped hooks 131, 141 are extended outward from the bottoms of the pivotal bolts 13, 14, respectively, for holding a coin rejection spring 38, wherein a retaining part 381 is located on the center of the coin rejection spring 38. Besides, a retaining plate 15 is formed in the front inside of the upper shell 1 near the key plate insertion slot 12. The retaining plate 15 has a protrudent center. Two protrudent plates are mounted on the backside of the protrudent center. In addition, the retaining plate 15 has two stair-shaped parts 151 on its both ends, respectively. An embedded trench is formed on the rear bottom of the retaining plate 15. Several retaining pillars 152 having slanted surfaces are mounted behind the embedded trench. A coupling pillar 153 is formed among the retaining pillars 152 facing the protrudent center of the retaining plate 15. The backside of the upper shell 1 is designed to be a marking region 16.

The stopping mechanism 3 has two swing arms 31. One of the swing arms 31 is explained since they have identical structures. A pivotal connection hole 32 is formed in a proper position on the front end of the swing arm 31, and the swing arm 31 has an arc-shaped, recessed edge 33 on its front end. An inward-facing hook 34 is formed on the rear end of the swing arm 31. Moreover, an inner notch 36 is formed on the bottom center of the swing arm 31. A pillar 35 is mounted in a proper position on the top of the outer edge of the rear end of the swing arm 31 for insertion into a spring 37.

The restoring mechanism 4 comprises two identical push plates 41 and a spring 42, wherein one of the push plates 41 is explained since they are identical in structure. A protrudent part having a slanted surface 411 is mounted in an upper portion on one end of the push plate 41, and a through hole 412 is formed on the push plate 41 under the protrudent part. In addition, a stair-shaped part 413 is formed in the upper portion on the other end of push plate 41. A coupling hole 421 is formed on the center of the spring 42. Besides, two ends of the spring 42 are inserted into the through holes 412 of the push plates 41, respectively.

The key plate 5 is connected to one end of a chain 54, and the other end of the chain 54 is coupled with the lower shell 2. A notch 51 is formed on the front end of the key plate 5. In addition, two notches are formed on the both sides of the key plate 5 for forming hooks 52, 53, respectively.

When in assembly, the push plates 41, which are coupled with the spring 42, are inserted into the embedded trench formed behind the retaining plate 15 so as to enable the slanted surface 411 of the protrudent part to face the key plate insertion slot 12. The coupling hole 421 of the spring 42 is screwed onto the coupling pillar 153 via a screw such that the spring 42 pushes the push plates 41 to lean against the retaining plate 15, thereby overlapping the stair-shaped parts 151 of the retaining plate 15 with the stair-shaped parts 413 of the push plates 41. Thereafter, the pivotal bolts 13, 14 of the upper shell 1 are inserted into the pivotal connection holes 32 of the swing arms 31 of the stopping mechanism 3 and screwed thereon via two screws, respectively. The pillars 35 are designed for hooking two ends of the spring 37 such that the stopping mechanism 3 is pivotally mounted above the restoring mechanism 4. After assembly, the recessed edges 33 and hooks 34 of the swing arms 31 are mounted on both sides of the coin insertion slot 11 and the key plate insertion slot 12, respectively.

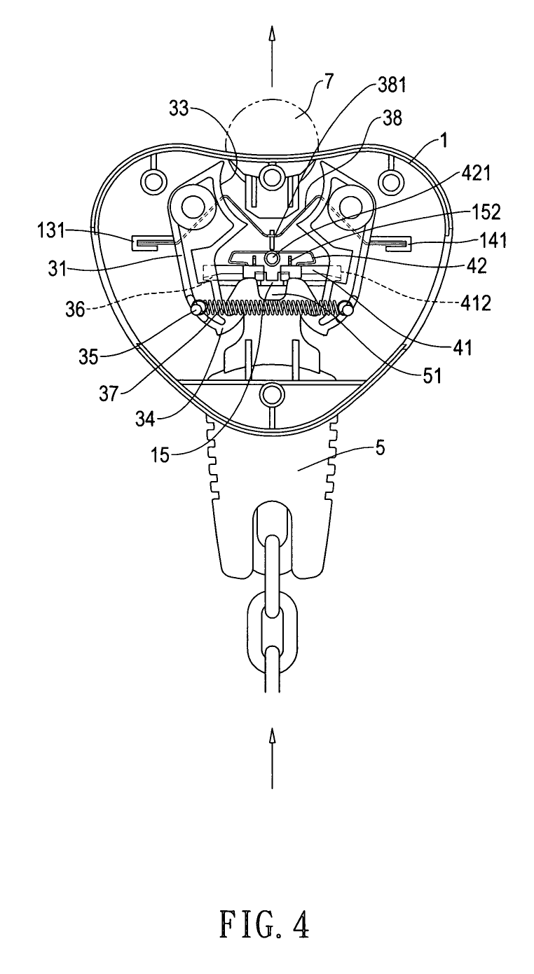

Referring to FIG. 1 through FIG. 4 simultaneously, when the key plate 5 is inserted into the key plat insertion slot 12, the borders of the recessed edges 33 of the swing arms 31 are aligned with the coin insertion slot 11. When a coin 7 is inserted into the coin insertion slot 11 and pushed inwardly to lean against the retaining part 381 of the spring 38, the swing arms 31 are mounted pivotally so the rear ends of the recesses edges 33 are pushed by the coin 7 to expand outward such that the rear ends of the swing arms 31 are located to lean against the stair-shaped parts 413 of the push plates 41. As a result, the hooks 52, 53 can be separated from the hooks 34 of the swing arms 31. On the contrary, when the key plate 5 is inserted into the key plate insertion slot 12, the notch 51 of the key plate 5 is located to face the protrudent center of the retaining plate 15. When the key plate 5 is further inserted inwardly, the push plates 41 are further pushed by the plate body oppositely on both sides of the notch 51. As a result, by using the slanted surface 411, the key plate 5 can maintain onward push force to slant the push plates backward such that the stair-shaped parts 413, which are originally leant on the bottom of the swing arms 31, are shifted to the notch 36. After the resistance force applied to the swing arms 31 disappears, the spring 37 sleeved onto the pillars 35 are shrunk synchronously so as to close the rear ends of the swing arms 31 for expanding the recessed edges 33 via the pivotal connection hole 32. In addition, the resistance force applied to the coin rejection spring 38 is thus disappeared to enable the retaining part 381 to restore its elasticity such that the coin 7 is rejected outward for getting the coin 7 back.

After the stopping mechanism 3 is pivotally connected to the pivotal bolts 13, 14, the recessed edges 33 of the swing arms 31, which are not in use, are aligned with the coin insertion slot 11. As long as the coin 7 is inserted into the coin insertion slot 11, the swing arms 31 are pushed by force and leant against the stair-shaped parts 413 such that the rear ends of the swing arms 31 are expanded outward and the front ends of the swing arms 31 are shrunk inward. Therefore, the distance between the front ends of the recessed edges 33 is smaller the diameter of the coin insertion slot 11. As a result, it is impossible to reject the coin 7 no matter how to apply the external force. Similarly, it is impossible to reject the key plate 5 no matter how to apply the external force since the hooks 34 of the swing arms 31 are located to hook the hooks 52, 53 of the key plate 5.

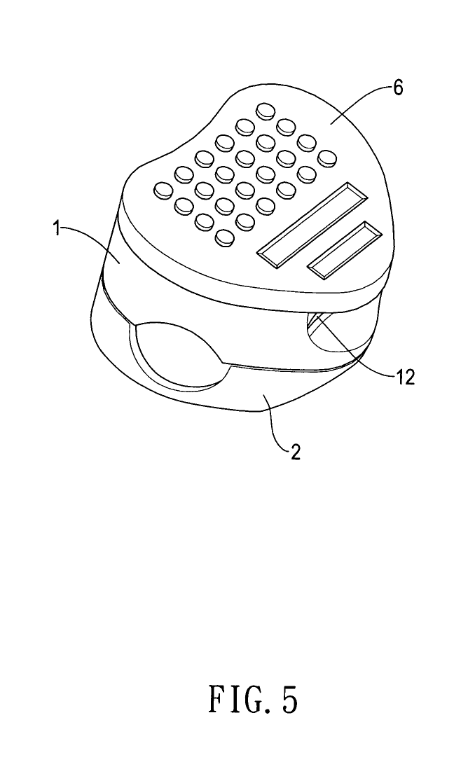

Referring to FIG. 1 and FIG. 5 simultaneously, the manufacturers can directly print the trademark on the marking region 16, which is located on the backside of the upper shell 1. Alternatively, a calculator 6 may be attached to the marking region 16 of the lock structure, which is coupled with a shopping cart, such that the consumer can use the calculator 6 for calculation and checkup.

It is apparent that the lock structure of the present invention provides the following advantages, wherein:

1. when the stopping mechanism is not is use, the hooks of the swing arm of the stopping mechanism and the hooks of the key plate are hooked together firmly so as to align the recessed edges of the stopping mechanism with the coin insertion slot and to prevent the external force from separating the key plate from the stopping mechanism; and

2. if there is a need to use the lock structure, the coin is inserted into the coin insertion slot, which has a diameter identical to that of the coin, and the coin is pushed inwardly to lean against the recessed edges of the swing arms, whereby the hooks, which are located on the rear ends of the swing arms, are expanded until the swing arms are stopped by the push plates such that the recessed edges can clip the coin tightly, wherein the distance between the ends of the recessed edges is smaller the diameter of the coin insertion slot to prevent the external force from separating the coin from the stopping mechanism.

In summary, the lock structure of the present invention can prevent the external force from separating the coin and the stopping mechanism. Accordingly, the present invention satisfies patentability and is therefore submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A lock structure comprising:
an upper shell and a lower shell, a traverse through hole being formed between the assembled upper and lower shells, a coin insertion slot and a key plate insertion slot being oppositely formed on the upper shell, a stopping mechanism being pivotally mounted inside the upper shell, a restoring mechanism being mounted below the stopping mechanism, the restoring mechanism and the stopping mechanism being driven and shifted by each other, two swing arms being oppositely, pivotally mounted on the stopping mechanism, two arc-shaped, recessed edges being formed on front ends of the swing arms, respectively, two hooks being mounted inwardly on rear ends of the swing arms, respectively, a first spring being coupled with the rear ends of the swing arms for forming a front clipping opening and a rear clipping opening to clip a coin or a key plate, the restoring mechanism being composed of a second spring and two push plates, the push plates being coupled with two ends of the second spring, respectively, whereby when the swing arms are coupled with the upper shell via a coupling hole of the second spring, a diameter of the first clipping opening is formed in accordance with a diameter of the coin.

2. The lock structure of claim 1, further comprising two pillars mounted on tops of the swing arms of the stopping mechanism near the hooks for hooking the first spring, two notches being formed on the bottoms of the swing arms near the centers thereof for holding the push plates of the restoring mechanism, two through holes for being inserted by the second spring being formed on the push plates of the restoring mechanism, two protrudent parts being formed in upper positions on first ends of the push plates, respectively, two stair-shaped parts being formed on second ends of the push plates, respectively.

3. The lock structure of claim 1, further comprising two pivotal bolts mounted on the upper shell and on both sides of the coin insertion slot, two trench-shaped hooks being extended outward from the bottoms of the pivotal bolts for holding a coin rejection spring having a central retaining part, a retaining plate being formed in the front inside of the upper shell near the key plate insertion slot, the retaining plate having a protrudent center, two stair-shaped parts being formed on both sides of the retaining plate, an embedded trench being formed on a rear bottom of the retaining plate, a plurality of retaining pillars being mounted on the retaining plate behind the embedded trench, a coupling pillar being formed among the retaining pillars facing the protrudent center of the retaining plate.

4. The lock structure of claim 3, wherein a calculator is attached to the backside of the upper shell.

5. The lock structure of claim 3, wherein the backside of the upper shell is a marking region.

6. The lock structure of claim 3, further comprising two pillars mounted on tops of the swing arms of the stopping mechanism near the hooks for hooking the first spring, two notches being formed on the bottoms of the swing arms near the centers thereof for holding the push plates of the restoring mechanism, two through holes for being inserted by the second spring being formed on the push plates of the restoring mechanism, two protrudent parts being formed in upper positions on first ends of the push plates, respectively, two stair-shaped parts being formed on second ends of the push plates, respectively.

7. The lock structure of claim 6, wherein the protrudent parts have slanted surfaces to enable the key plate to maintain an onward push force.

8. The lock structure of claim 3, wherein the key plate for insertion into the upper shell has a center notch to avoid the collision between the key plate and the protrudent center of the retaining plate and two upward slanted notches are formed on both sides of the key plat for forming two downward-facing hooks, respectively.
